(19) United States
(12) Patent Application Publication
(10) Pub. No.: US 2009/0288960 A1
(43) Pub. Date: Nov. 26, 2009

(54) Rapid Detection of Anti-Chromatin Autoantibodies in Human Serum using a Portable Electrochemical Biosensor

(76) Inventors: Robert Rubin, Tijeras, NM (US); Ravil Sitdikov, Albuquerque, NM (US); Plamen Atanassov, Albuquerque, NM (US); Gabriel Lopez, Albuquerque, NM (US); Konstantin Konstantinov, Albuquerque, NM (US)

Correspondence Address: GONZALES PATENT SERVICES, 4605 CONGRESS AVE. NW, ALBUQUERQUE, NM, 87114, US

(21) Appl. No.: 12/370,403

(22) Filed: Feb. 12, 2009

Related U.S. Application Data
(60) Provisional application No. 61/065,425, filed on Feb. 12, 2008.
(60) Provisional application No. 61/100,152, filed on Sep. 25, 2008.

(51) Int. Cl. G01N 27/416; G01N 27/26

(52) U.S. Cl. 205/777.5; 204/403.14

(57) ABSTRACT

A rapid electrochemical flow-through sensor and method for detecting the presence of autoantibodies in a fluid sample such as blood is shown and described. The sensor may take either a single- or multi-plexed form. The sensor comprises a fluid inlet, a reaction region comprising immobilized autoantigens and an electrode assembly, and a fluid outlet.

### CROSS-REFERENCE TO RELATED APPLICATIONS

The following application claims benefit of U.S. Provisional Patent Application Nos. 61/065,425, filed Jan. 12, 2008 and 61/100,152, filed Sep. 25, 2008, each of which is hereby incorporated by reference in its entirety.

### STATEMENT REGARDING GOVERNMENT SPONSORED RESEARCH

This invention was made with Government support under Grants Nos. DMR-0611616 and CTS-0332315 awarded by the National Science Foundation. The U.S. Government has certain rights in this invention.

### BACKGROUND

Laboratory measurement and monitoring of biomarkers are mandatory components in the management of clinical disease. Numerous technical approaches and methodologies have been devised to measure antibodies in clinically relevant samples. This can be a challenging undertaking because the specific antibody of interest is generally present in serum in a vast excess of irrelevant immunoglobulin with essentially the same composition and chemical properties. While solid phase assays have generally come to dominate the immunoassay world, most of these involve a substantial time for the read-out using expensive, non-portable equipment that requires considerable technical effort to operate, interpret, and report. Consequently, there is a need for instrumentation that can be produced inexpensively and operated easily at a point-of-care clinic or home environment, with portable biosensors becoming one of the fastest growing technological developments (Melanson, 2007).

Autoantibodies are a group of antibodies (immuno proteins) that can target and damage specific tissues or organs of the body. Normally the immune system recognizes foreign substances (“non-self”) and ignores the body's own cells (“self”). When the immune system ceases to recognize one or more of the body's normal constituents as “self,” it may produce autoantibodies that attack its own cells, tissues, and/or organs, causing inflammation and damage. The cause(s) of this failure of immune tolerance to self are not well understood and are often associated with chronic autoimmune disease. Disorders associated with systemic autoantibodies (those that affect multiple organs or systems) can be difficult to diagnose without laboratory information on specific autoantibody levels.

Rheumatic diseases are common and confront society with serious medical, social and financial burdens imposed by their chronic and debilitating nature (Davidson and Diamond, 2001). Each autoimmune rheumatic disease is associated with a particular set of autoantibody markers, which are used to define disease, predict flares, or monitor efficacy of therapy (Lernmark, 2001).

For example, systemic lupus erythematosus (SLE) is associated with significant morbidity and its early diagnosis is of significant clinical importance. SLE is the most diverse of the autoimmune diseases and it is characterized by the production of multiple autoantibodies to autoantigens. Among the current laboratory assays used for the diagnosis of SLE, the detection of anti-double stranded DNA antibodies (anti-DNA,) is regarded as a highly specific indicator of SLE. Anti-chromatin antibodies, which include anti-DNA antibodies, are an early and sensitive indicator of SLE although not unique to this autoimmune disease. See, for example (Rahman and Isenberg, 2008); (Rubin and Fritzler, 2007).

Typically, these tests are performed in centralized clinical laboratories where expensive equipment can be consolidated and quality control of assays sustained. Accordingly, current methods for detection of autoantibodies, including those associated with SLE, continue to be expensive, protracted, and labor intensive. Furthermore, preserving the identity of assay results when testing multiple samples requires constant vigilance. Consequently, this field of laboratory testing may be especially amenable to biosensor applications.

Biosensors based on electrochemical reactions have emerged as a highly promising technique for the measurement of clinically-relevant analytes (Privett et al., 2008). They are ideally suited for clinical applications due to their high sensitivity and selectivity, portable field-based size, rapid response time and suitability for mass fabrication at low-cost (Wikins and Sitdikov R., 2006). Despite their potential advantages over laboratory-based analytical techniques, numerous issues remain to be addressed before portable biosensors for antibodies are ready for routine patient use (Wang et al., 2008). While biosensors generally show excellent characteristics for synthetic or pristine laboratory samples, they are often not sufficiently robust for real-life samples. Limitations of portable biosensors include operational stability of the biological receptor and/or the physical transducer, poor reproducibility between sensors and reduced specificity in complex matrices, resulting in high background signals. Frequently, therefore, the main obstacles are encountered once the sensor is used outside the laboratory and applied to in situ sample monitoring conditions (Andreescu. S and Sadik, 2004).

Accordingly, there is demand for novel biosensors that address the above-identified disadvantages and assays suitable for use with these biosensors.

### SUMMARY

According to an embodiment, the present disclosure provides assays and systems employing electrochemical sensor technology for the measurement of autoantibodies in human sera.

### BRIEF DESCRIPTION OF THE DRAWINGS

FIG. 1 is a flow chart of a method according to an embodiment of the present disclosure.

FIG. 2 is a schematic illustration of a single well flow-through electrochemical immunoassay detection unit according to an embodiment of the present disclosure.

FIG. 3 is a schematic illustration of a multiplexed flow-through immunosensor assembly according to another embodiment of the present disclosure. A depicts an exploded view of the sensor while B depicts the assembled sensor.

FIG. 4 is a graph depicting the kinetics of anti-chromatin antibody response. Six sera from patients with SLE were applied to an anti-chromatin biosensor, and the signal output was measured over time.

FIG. 5 is a visual record of reactivity. Six SLE sera were tested in the biosensor and signal output in microamperes was recorded at 7 minutes (B). TMB product accumulation on the chromatin-coated membrane is shown (A). The top and next position used serum diluent and a normal human serum, respectively, in the first stage of the assay.

FIG. 6 depicts the relationship between output with the biosensor vs. ELISA with a panel of SLE sera.

FIG. 7 shows the reactivity of normal human sera. Sera from normal people were applied to the biosensor and the signal output was measured at 7 minutes. Also shown for comparison is the reactivity of SLE sera with low and moderate anti-chromatin activity.

### DETAILED DESCRIPTION

According to an embodiment, the present disclosure provides simple, fast, selective, and highly sensitive electrochemical methods of immunoassay for detection of autoantibodies in human and/or animal blood. One embodiment of the methods of electrochemical immunoassay is based on conjunction of immobilized autoantigen(s) on the surface of a flow-through transducer array followed by immunospecific interaction and electrochemical detection of an enzyme-label generated product.

As shown in FIG. 1, an exemplary method comprises introducing a blood serum sample to a flow-through electrochemical sensor; capturing specific autoantibodies, for example via immobilized autoantigen(s), from patient serum in a reaction region within the sensor; allowing unbound molecules to flow out of the reaction region, which may, for example, include the introduction of a washing solution; introducing a detection antibody, for example anti-human IgG labeled with an enzyme such as horseradish peroxidase (HRP) or alkaline phosphatase (AP) to the reaction region; allowing unbound molecules to flow out of the reaction region, which again may, for example, include the introduction of a washing solution; and electrochemically detecting the autoantibodies using the appropriate enzyme substrate(s).

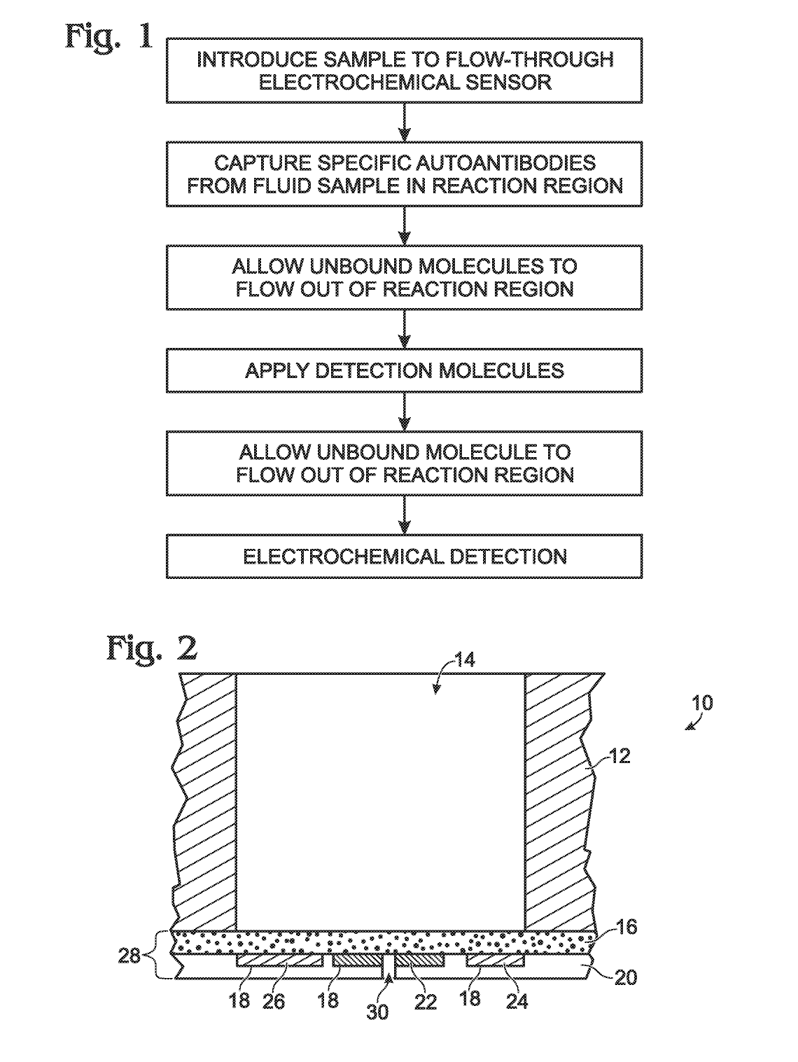

An exemplary suitable flow-through electrochemical sensor 10 is shown in FIG. 2. The sensor may comprise a body 12 including a channel 14 into which the sample may be introduced. As shown, within channel 14 is a porous substrate 16 which, in turn, is in fluid contact with an electrode assembly 18. Electrode assembly 18 may include, for example, a substrate 20 having a working electrode 22, a reference electrode 24, and an optional counter electrode 26 situated thereon. According to some embodiments, electrodes 22, 24, and 26 may be screen-printed, etched, plated, or layered, using then-film technologies, onto substrate 20. In combination, the porous substrate 16 and electrode assembly 18 form a reaction region 28, in which a variety of interactions, reactions, and/or detections may take place. As shown, working electrode 22 may include a hole so as to form an exit channel 30, through which fluid may flow out of the reaction region and into, for example, a waste reservoir (not shown). Other suitable electrochemical sensors are shown and described, for example, in U.S. patent application Ser. No. 12/349,857, which claims priority to U.S. Provisional Patent Application No. 61/010,227, both of which are hereby incorporated by reference. An advantage of the present flow-through system over previously described well-based electrochemical sensors is that unbound molecules and other waste products are easily removed from the reaction region during normal fluid flow, significantly increasing the signal to noise ratio and minimizing disturbance to the system that can be caused by the more aggressive washing techniques that are required in the well-based systems.

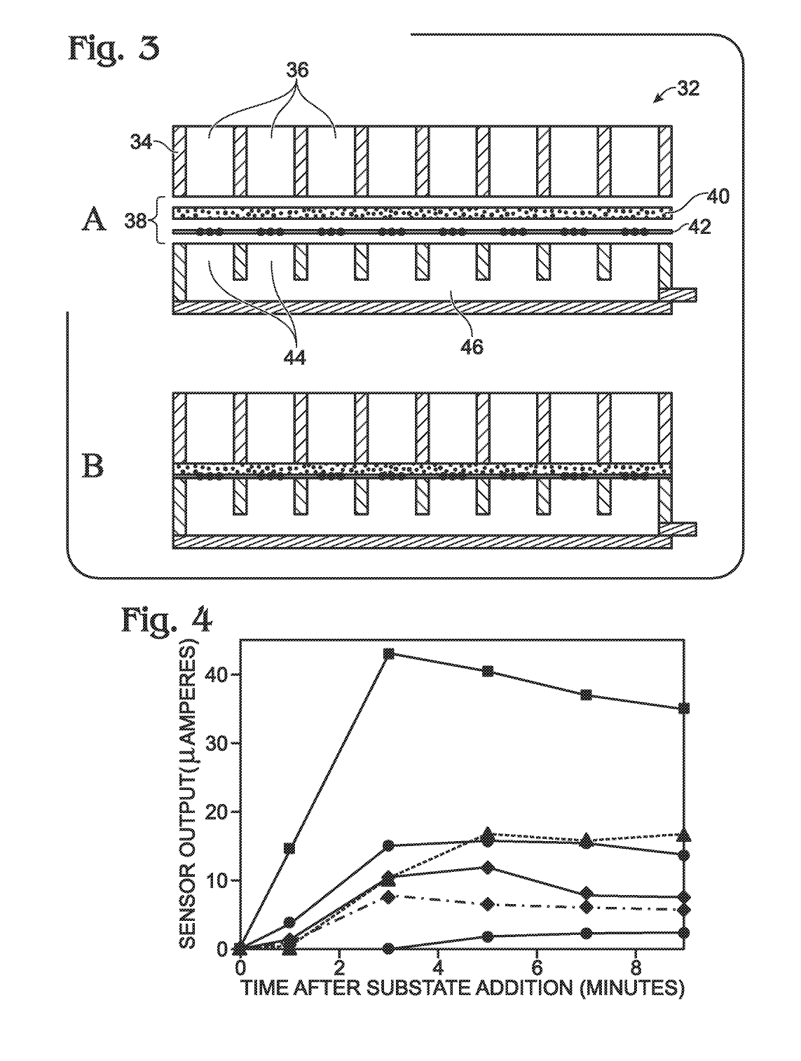

FIG. 3 provides an alternate fluid flow device 32 comprising a multi-channel flow-through system. FIG. 3A shows an exploded view of the device, while FIG. 3B shows the assembled device. In this device, a single housing 34 comprises multiple channels 36, each channel including a reaction region 38 comprising a porous substrate 40, and an electrode assembly 42. As with the device shown in FIG. 2, each electrode assembly may include a working, reference, and optional counter electrode and each working electrode may have a hole through it which forms an exit channel 44 through which fluid may flow out of the reaction region and into a shared waste reservoir 46. As with the device shown in FIG. 2, each porous substrate 40 may be an immunoselective membrane designed to capture a target analyte such as a specific autoantibody. The immunoselective membranes in a single device may have the same or different capture agents immobilized thereto and may, therefore, be designed to capture the same or different target analytes.

For example, those of skill in the art will be aware that a single autoantibody test may not be diagnostic in and of itself. Typically, individual autoantibody results should be considered both individually and as a group. Accordingly, in some embodiments a multiplexed sensor such as that shown in FIG. 3 may be designed to assay for the presence of multiple autoantibodies form a single patient sample (or multiple samples from the same patient) so as to provide a wider spectrum of data and a more accurate diagnostic tool.

According to some embodiments, porous substrate 16 may be an immuno-selective membrane having an autoantibody-specific capture agent immobilized thereto. Exemplary autoantibody-specific capture agents include, but are not limited to, autoantigens, H1-stripped chromatin, nucleosome core particles, and the like. Some of the more common autoantibodies that are used to identify a variety of autoimmune disorders include systemic autoantibodies such as: Anti-Nuclear Antibody (ANA); Antineutrophil Cytoplamic Antibody (ANCA); Anti-Double Strand DNA (Anti-dsDNA); Anti-Sjorgren's Sydrome A (Anti-SS-A) (Ro); Anti-Sjogren's Sydrome B (Anti-SS-B) (La); Rheumatoid Factor (RF); Anti-Jo-1; Anti-Ribonuclear Protein (Anti-RNP); Anti-Smith (Anti-Sm); Antiscleroderma Antibody (Anti-scl-70); and Cardiolipin autoantibodies; and organ-specific autoantibodies such as: Thyroid Antibodies; Anti-Smooth Muscle Antibody (ASMA); Diabetes Autoantibodies; Anti-Mitochondrial Antibody (AMA); and Liver-Kidney Microsomal autoantibodies. Accordingly, various embodiments of the presently described sensor may include an immuno-selective membrane having one or more capture agents specific to one or more of these autoantibodies.

According to various embodiments, a blood serum sample suspected of containing an autoantibody of interest (target autoantibody) is introduced into the well 14 so that it contacts the immunoselective membrane under suitable conditions such that any target autoantibody within the sample can be captured by the immobilized capture agent. Those of skill in the art will appreciate that the specific conditions must be tailored for the specific capture agent and target autoantibody being used. However, specific conditions for a detection system for anti-chromatin antibodies, which are sensitive and specific for SLE and drug induced lupus (DIL) are provided herein in detail in the examples section.

Once captured by the immuno-selective membrane, a product of the target-capture agent interaction, a product of the interaction of the target with another agent (both of which may be referred to herein as the “product”) and/or the target autoantibody is presented to the working sensor due to the proximity of the immuno-selective membrane to the sensor assembly. According to some embodiments, the concentration of the product is then discontinuously measured by the current produced when the product is electrically reduced at the appropriate set voltage.

Fluid flow through the system may be encouraged through the use of a pump, gravity, capillarity wicking, or any other suitable method.

According to an embodiment, blood serum from a patient could be introduced into a single or multi-channel flow through sensor such as those described above configured to measure the electro-reduction current of oxidized tetramethylbenzidine (TMB+) formed from TMB in a catalytic cycle involving HRP labeled antibody, hydrogen peroxide (H₂O₂) and TMB.

According to a specific embodiment, the present disclosure provides a method for detecting the presence of anti-chromatin antibodies in blood sera. Anti-chromatin antibodies are an early and sensitive indicator of systemic lupus erythematosus (SLE). Accordingly, the present disclosure further provides a diagnostic test for SLE.

For example, a sensor such as those described above may include a porous substrate having purified chromatin stripped of histone H1 immobilized thereto. Blood sera can then be introduced into the sensor under suitable conditions such that an antigen-antibody interaction occurs. The immune complexes can then be detected with a reagent antibody conjugated to HRP. Enzyme catalyzed product formation may then be detected in real-time by a flow-through electrochemical transducer.

As described in further detail in the Examples section, the presently described methods of electrochemical detection compared favorably with ELISA using a sample of 30 SLE sera (r=0.9), and non-specific binding by normal serum immunoglobulin was undetectable. The electrochemical sensor assay required <20 minutes processing time and utilized a hand-held apparatus with a disposable electrode. These results demonstrate the applicability of this technology to the rapid measurement of a clinically relevant analyte with an apparatus of potential simplicity and low cost.

### Examples

### Human Serum Samples

Sera from patients diagnosed with SLE based on accepted criteria (Tan et al., 1982); (Hochberg, 1997) have been previously described (Burlingame et al., 1994). Samples were stored at −20° C. Normal human sera (NHS) were obtained from blood bank and laboratory personnel and stored and used in the same way as the SLE sera.

### Preparation of Immobilized Antigen on Membranes

Chromatin was purified from calf thymus, stripped of histone H1 (Lutter, 1978) and stored in 50% glycerol at −20° C. Its concentration (of the DNA component) was determined by absorbance at 260 mμ based on E=25 for 1 mg/ml. Protein/DNA ratio=1.27 by BCA assay (see below). On the day of use chromatin was diluted to 20 μg/ml (in DNA, 25 μg/ml histone protein) in phosphate-buffered saline (“PBS”) (0.01 M Na phosphate, 0.14 M NaCl, +0.01% thimerosal (Sigma), pH 7.2) at 5° C. Unmodified hydrophobic polyvinylidene fluoride membranes of 0.45 μm pore size (“Immobilon-P PVDF membranes”, Millipore Corp., Bellerica, Mass. or “BioTrace PVDF membranes”, Pall Life Sciences Corp., Port Washington, N.Y.) were cut to 1.5×7.6 cm, wetted in methanol, hydrated and immersed in 10-20 ml chromatin solution. After overnight incubation at 5° C., the membrane was transferred to a solution of 5% nonfat dry milk (Kroger Corp., Cincinnati, Ohio) or 1% bovine casein (Pierce) in PBS for 1-3 h, followed by 1% Tween-20 (polyoxyethylene sorbitan monolaurate; Sigma) in PBS for 0.5-1.0 h and finally rinsed several times in 0.05% Tween-20 in PBS (“PBS-tween”).

### Protein Determination

The amount of chromatin protein bound to the PVDF membrane and the ELISA plate well was determined by the bicinchoninic acid colorometric assay (“BCA”, Pierce Biotechnology, Inc.). Replicate 260 mm² pieces of PVDF membrane were adsorbed with chromatin and washed under the standardized conditions described above except they were not post-coated with blocking solution. Membranes were immersed in 2.0 ml of the BCA reagent mix and 0.1 ml saline. Protein bound to the ELISA wells was determined in a similar way except 0.2 ml of the BCA reagent and 10 μl saline were added to each well, and the contents of 5 wells were pooled for spectrophotometric determination. The 30 minute incubation was performed at 37° C. per manufacturer's recommendation. Standard curves were generated either in test tubes or microtiter plate wells using calf thymus histone (Worthington Chemical Co.), whose concentration was determined by absorbance at 230 mμ based on E=4.2 for a 1 mg/ml solution (Chung et al., 1978). Background color development from membranes or plate wells to which no chromatin was added was subtracted from the appropriate samples.

### Immunosensor Design

A chromatin-coated membrane was placed over a plastic strip on which 8, 3-electrode sensors were screen printed at a center-to-center distance of 0.9 cm. (AndCare, Alderon, Durham N.C.). A lucite block with 8, 6 mm diameter holes aligned to the electrode strip was placed above the membrane so that up to 0.3 ml solution could be introduced onto a 6 mm diameter circle of exposed membrane. Below the electrode strip was place another lucite block with eight 6 mm diameter aligned cavities, which was sealed with a plastic gasket at its interface with the electrode strip, and works as a waste reservoir. A 1 mm diameter perpendicular hole interconnecting the eight lower sample holes exited the lower chamber (waste reservoir) through a stainless-steel hollow rod outlet to which a vacuum can be applied. The entire assembly, which measured 76 mm×35 mm×20 mm, was held together with a clamp and is further described in Results.

### Amperometric Immunoassay

The test sera were diluted 1:50 in “serum diluent” consisting of 1 mg/ml gelatin (Baker Chem. Co., Phillipsburg, N.J.), 0.75 mg/ml bovine gamma globulin (Calbiochem/EMD)+1 mg/ml bovine serum albumin (Cohn fraction V; Sigma)+0.05% tween-20, +0.01% thimerosal in PBS. The serum diluent was also supplemented with 1 mg/ml non-fat dry milk or casein to block binding of antibodies to milk proteins observed in some sera. Diluted sera were ultrafiltered through 0.45 μm pore size membranes. After loading each of the 8 wells of the assembly with 200 μl diluted serum, a weak vacuum was applied to the lower chamber using a peristaltic pump (403 U/VM4, W-M Alitea AB, Stockholm, Sweden) set at 15 RPM to draw the samples through the membrane over the course of ˜1 min. A volume of 0.2 ml PBS-tween was added to each well, and drawn through by vacuum. This was repeated for a total of 3 wash cycles. Then 0.2 ml peroxidase-conjugated goat anti-human IgG (Caltag, San Francisco, Calif.) diluted 1:1000 in serum diluent was added to each well and drawn through the membrane by vacuum. Wells were then washed 3× with PBS-tween. To all the wells was added simultaneously 0.1 ml peroxidase substrate solution hydrogen peroxide (H₂O₂)+3,3′,5,5′ tetramethylbenzidine (“TMB liquid substrate solution for ELISA”, Sigma) at room temperature, and ˜10% of the solution was immediately drawn through the membrane. The electrode terminals were connected through a cable to an amperometric reader (ANDCare 800 8-well electrochemical strip reader, Alderon, Durham N.C.), whose parameter settings and output were monitored by interfacing with a laptop computer using the manufacturer's software. Readings were generally made at 2 min intervals, preceded by a 10 sec vacuum pulse to pull ˜10% of the substrate solution through the membrane. The potential between the working and reference/counter electrodes was set at −100 mV, and 5 ms voltage pulses were sequentially and repeatedly applied to each working electrode. Using this intermittent pulse amperometry over the course of 4 sec at each electrically-addressed well position, 20 readings of current were measured during the last microseconds of each pulse, and these were saved and averaged to produce the recorded signal at the selected timepoint for each sample. The electrical current maximum was typically set at 100 microamperes, the lowest sensitivity setting of the ANDCare Reader. Total processing time was typically less than 20 min from the time of sample addition to the last reading.

### Determination of Anti-Chromatin Activity by ELISA

Anti-chromatin antibody quantification was performed by ELISA as previously described (Burlingame and Rubin, 1990); (Burlingame and Rubin, 2002). Briefly, Immulon 2HB microtiter plates (Dynex Laboratories, Inc., Alexandria, Va.) were coated with H1-stripped chromatin at 5.0 μg/ml in PBS overnight. Wells were blocked with 1% gelatin for 1 h. After rinsing with PBS-tween, 200 μl serum diluted 1:200 in “serum diluent” (described above) were added in duplicate and incubated for 2 h with agitation at room temperature. Plates were washed with PBS-tween and wells incubated with agitation for 1.5 h with peroxidase-conjugated goat anti-human IgG diluted 1:1000 in serum diluent. After washing with PBS-tween, colored product was developed during 1 h using 0.005% H₂O₂+1 mg/ml 2,2′ azino-bis(3-ethylbenzthiazoline-6-sulfonic acid) (ABTS) as the secondary substrate in McIlvaine's buffer, pH 4.6. Optical densities (O.D.) at 410 mμ were measured using a Thermo Labsystems (Fisher) reader, and values beyond the range of direct measurement at 1 h were extrapolated from O.D. at earlier time-points as described (Burlingame & Rubin, 1990) so that antibody activity of all samples was expressed as O.D. at 1 h.

### Assay Procedure and Analysis

The ELISA and amperometric immunoassays were performed with the same reagents where possible and within a two month period. Each amperometric immunoassay included a positive control sample and a negative control with only secondary antibody as well as several normal sera. Amperometric readouts were corrected for secondary antibody background binding by subtraction using the signal produced by the negative control at each timepoint, which was typically <1 microamperes. Variability in the electrode response between assays due largely to repetitive use necessitated normalizing the readouts for samples run in different assays. This was done by using the average readout of the 13 individual runs of the same positive control to calculate a correction factor, the ratio of this value to the individual run value, and multiplying this number by the value obtained for the test sample determined in the same run. In some experiments chromatin-coated strips were blocked with casein and submerged in PBS-tween for 0, 8, 15 and 22 days at 5° C. prior to assay with various SLE and NHS; in this case background subtraction but no inter-run normalization was performed.

### Results

### Multichannel Flow-Through Immunosensor Design

A flow-through immunoassay procedure was applied to an electrochemical detection system and adapted for measuring anti-chromatin autoantibodies in serum from human blood. The biosensor consists of a polymeric membrane with immobilized chromatin on which the antigen-antibody interaction occurs. These immune complexes are detected with a reagent antibody conjugated to peroxidase, and enzyme catalyzed product formation is detected in real-time by a flow-through 3-electrode transducer. The product sensing electrode set can be fabricated as a free-standing single channel device or arranged in an array of several (in this case 8) channels machined from a single plastic block.

The array of eight 3-electrode sensors comprised screen printed electrode assemblies of carbon working, silver counter, and silver-chloride reference inks and was situated perpendicular to the direction of liquid flow through the well. This design minimizes sweeping action due to lateral fluid flow across the surface of the working electrode and allows enzymatic reaction products to form adjacent to the electrode. The flow-through design also substantially enhances antigen-antibody binding by reducing the thickness of the fluid film, which in turn reduces diffusional constraints to immuno-interactions. This improves the rates of bimolecular interactions between immobilized chromatin, the analyte serum antibodies and the enzyme-conjugated detecting antibodies. Together with the use of intermittent pulse amperometry to affect electrochemical transduction, the apparatus is designed to enhance the magnitude of the signal output.

### Electrochemical Detection of Anti-Chromatin Antibodies

Diluted serum samples and subsequently the peroxidase-conjugate secondary antibody were introduced manually into an 8-well manifold device. Immediately after their addition, the fluid was drawn by negative pressure over the course of about one minute through the porous, chromatin-coated membrane. The amount of peroxidase-labeled antibody bound to the membrane was manifested after addition of H₂O₂ and TMB, the primary and secondary substrates, respectively. In order to ensure contact with the electrode of the oxidized TMB product that accumulated within and above the membrane, a brief vacuum pulse was applied just before each reading. Upon applying intermittent millisecond pulses of electrical potential, a current is generated due to the electro-reduction of TMB⁺ to TMB. Current signals are measured during the last microseconds of each pulse.

FIG. 4 shows typical results of signals from one assay of six SLE samples with various levels of anti-chromatin antibodies. A rapid rise in current occurred during the first few minutes, after which relatively stable readings were obtained. Presumably, product initially accumulated more rapidly than the rate of draw-down into the electrode, followed by a slowing of the catalytic reaction, due to substrate depletion and possibly inhibition of peroxidase by H₂O₂ (Hernandez-Ruiz et al., 2001) or the TMB diimine oxidation product. After the first few minutes, the readout was relatively stable, presumably reflecting the approximate steady-state concentration of product in contact with the electrode. Blue-colored product representing the charge-transfer complex of the parent diamine and the diimine oxidation product (Josephy et al., 1982), also accumulated transiently on the membrane, and the amount of deposited product approximately correlated with the amperometric readout of the sample (FIG. 5).

Comparison with ELISA

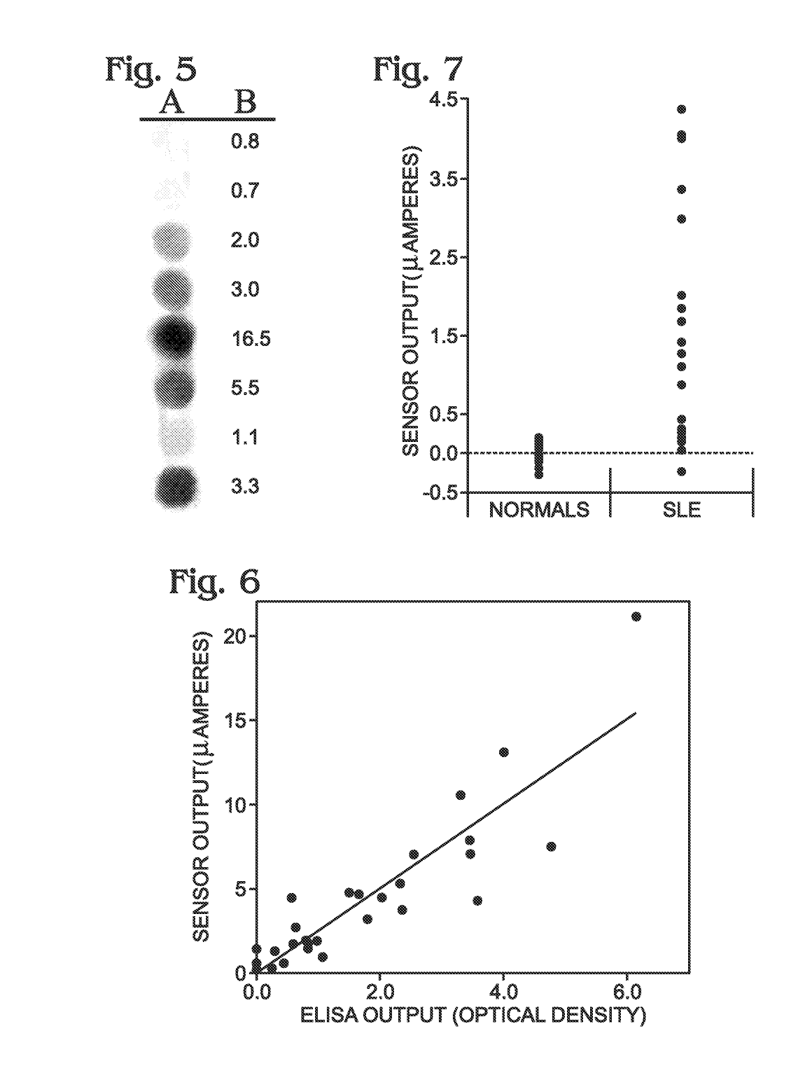

The signals produced with sera from 30 SLE patients using the electrochemical sensor were compared to those produced by ELISA, the standard and widely-used method for measuring anti-chromatin antibodies. FIG. 6 compares the results of the 7 minute electrical readout of the sensor with the one hour optical density value generated in the ELISA using the same samples and detecting antibody. It should be noted that while the two assays both employed a peroxidase-based amplification systems, the sensor measured the current associated with the electrochemical reduction of the oxidized TMB product, while the ELISA simply measured the optical density of the oxidized ABTS product. The assays showed a high degree of correlation (r=0.89); similar results were seen at the 3 and 5 minute readings (r=0.87 and 0.87, respectively). The slope of the line remained essentially unchanged between 3 and 7 minutes, indicating that the fluidics achieved maximum sensitivity within 3 minutes after addition of the substrate.

### Normal Serum Binding in the Electrochemical Sensor

Although the data in FIG. 6 indicate that there was little in the way of background binding in the electrochemical sensor assay, normal sera were also tested in this system. As shown in the FIG. 7 using an expanded scale, normal sera showed no net IgG binding in this assay. Some normal sera had negative values because they displayed lower background binding than the secondary antibody alone, which was subtracted from the values shown in the figures. Apparently, unknown components of some normal sera inhibit the marginal but detectable binding of the secondary antibody. Overall, normal serum binding was not a problem in this electrochemical sensor system.

### Quantity of Immobilized Antigen

We also determined the amount of protein bound to the PVDF membrane and the polystyrene microtiter plate well. The area of the ˜7 mm diameter membrane exposed to the analytes contained 2.6 μg±0.26 (RSD.) protein while the ELISA plate had 0.29 μg/well when coated at 5 μg/ml (1 μg/well) and 0.35±0.17 (RSD) μg/well when coated at 20 μg/ml. This corresponds to 69 μg/mm² and up to 2.2 μg/mm² immobilized chromatin on the membrane and the polystyrene, respectively.

### Stability of Antigen-Coated Membrane

The effect of short-term storage of the antigen-coated membrane was investigated. As shown in Table 1, storage of chromatin-coated membranes up to three weeks had no effect on their antigenicity when compared to membranes prepared the day of use. This suggests that long-term storage of protein-coated membranes will be feasible.

TABLE 1
Anti-chromatin antibody reactivity of membranes stored
for 22 days vs. used the same day of preparation.

Antibody response in μA after
storage (days)*

| sample | 0 | 22 |
|---|---|---|
| SLE1 | 4.35 ± 1.61 | 4.05 ± 1.32 |
| SLE2 | 4.70 ± 1.71 | 6.31 ± 0.55 |
| NHS | 0.28 ± 0.11 | 0.15 ± 0.12 |

*Shown are 5 min readouts (±RSD) of duplicate determinations using two SLE sera with moderate anti-chromatin activity and one normal serum. Similar results were obtained at 7 minutes and with membranes stored for 8 and 15 days

### Discussion

Electrochemical Sensor Vs. ELISA

The present adaptation of an amperometric sensor allowed quantitative detection of a specific IgG autoantibody in human serum with negligible binding of IgG from normal serum. The strong correlation between this method and a standard ELISA for measuring anti-chromatin antibodies indicates that both assays had comparable sensitivity, specificity, dynamic range and discriminating ability. However, the electrochemical sensor system was much faster than the ELISA method and employed instrumentation that could readily be fabricated into a portable, hand-held device.

Differences in design and signal generator account for the higher sensitivity of the electrochemical sensor over the ELISA method. Because polyvinylidene fluoride membrane used as the immunoreactive solid phase in the electrochemical sensor has a microporous interior and consists of a wettable hydrophobic polymer, it has a high protein binding capacity (Starita-Geribaldi and Sudaka, 1990). Approximately 30× as much chromatin was bound to the PVDF membrane compared to polystyrene based on surface area, resulting in ˜8-fold more exposed antigen, despite the antigen-coated region of the sensor occupying only one-fourth the surface area of the microtiter plate well. Together with the lower serum dilution and the use of fluidics to drive antibody into the antigen-coated solid phase, the rates of bimolecular antigen/antibody interactions were increased, resulting in an assay time of 15-20 minutes for the electrochemical sensor compared to 4-5 hours for the ELISA. Also, the use of intermittent pulse amperometry produces substantially greater electrical signals than differential pulse or direct current amperometry due to less depletion of the analyte during the period of measurement (Wojciechowski et al., 1999).

Minimizing molecular interactions other than those intended to detect is a critical characteristic of an immunoassay, largely determining the positive/negative discriminatory capacity. In measuring specific antibodies in non-pristine or complex fluids, binding of irrelevant immunoglobulin to hydrophobic surfaces has been a major obstacle in the development of biosensors (Veetil and Ye, 2007). By using appropriate agents to block non-specific interactions, no background binding of non-immune IgG was detected in the current system. We did not determine absolute lower-limit of detection or maximum sensitivity of the system because our goal was limited to comparison to an existing assay in a clinically relevant setting. However, it is likely that antigen detection using a capture antibody on the solid phase could achieve substantially higher sensitivity than most current methodologies because of the high protein-binding capacity of the solid phase and the combined amplifying power of the secondary antibody, enzyme substrate and electronics.

### Importance of Autoantibody Measurement and Alternative Methods

Detection of serum autoantibodies is standard practice for the diagnosis and classification of autoimmune rheumatic diseases (Sheldon, 2004) and has been increasingly used for detection of cancer (Tan and Zhang, 2008); (Lu et al., 2008), neurological disorders (Zifman and Amital, 2008); (Buckley and Vincent, 2005) and occupational exposure (Cooper et al., 2006). Several novel platforms have been recently adapted to measurement of autoantibodies including surface plasmon resonance imaging (Metzger et al., 2007); (Buhl et al., 2007); (Lokate et al., 2007); (Kurowska et al., 2006), quartz crystal microbalance analysis (Drouvalakis et al., 2008) and electrical impedence spectroscopy (Balkenhohl and Lisdat, 2007). While in some cases approaching comparable sensitivity and specificity to existing methodologies, initial cost and complexity of operation suggest that these technologies would be more appropriate for a centralized clinical laboratory where multiplex analyses would be of value.

For small clinics or remote clinical settings, disposable, amperometric-based biosensors have emerged as diagnostic devices that combine point-of-care screening analysis with accurate, low cost systems and with minimal operator involvement (Ribone et al., 2006). Recent applications of this class of sensor include determination of tumor markers (Wu et al., 2007), liver disease markers (Song et al., 2007) and purified IgG antibody to West Nile virus (Ionescu et al., 2007). We believe the current system is the first report of the successful adaptation of a potentially portable electrochemical biosensor for quantitative measurement of antibodies in human serum.

### CONCLUSIONS

The current system applied principles of electrochemical signal transduction and microfluidics to a small biosensor for the measurement antibodies to chromatin, an important autoantibody in the diagnosis and management of patients with systemic lupus erythematosus. The entire immunoassay required only 20 minutes processing time but produced signals of comparable magnitude to and which were highly correlative with a standard immunoassay. With the application of disposable screen-printed electrodes and further miniaturization, this device has the potential to make practical the measurement of antibodies in near real-time and in remote clinical settings where centralized diagnostic laboratories are unavailable.

### REFERENCES

The following are incorporated by reference in their entirety:
Andreescu. S, Sadik, A. O., 2004. Pure Appl. Chem. 76, 861-878.
Balkenhohl, T., Lisdat, F., 2007. Anal. Chim. Acta 597(1), 50-57.
Buckley, C., Vincent, A., 2005. Nat. Clin. Pract. Neurol. 1(1), 22-33.
Buhl, A., Metzger, J. H., Heegaard, N. H., von Landenberg, P., Fleck, M., Luppa, P. B., 2007. Clin. Chem. 53(2), 334-341.
Burlingame, R. W., Boey, M. L., Starkebaum, G., Rubin, R. L., 1994. J. Clin. Invest. 94, 184-192.
Burlingame, R. W., Rubin, R. L., 1990. J. Immunol. Methods 134, 187-199.
Burlingame, R. W., Rubin, R. L., 2002. In: Rose, N. R., Hamilton, R. G., Detrick, B. (Eds.), Manual of Clinical Laboratory Immunology, 6 ed. ASM Press, Washington, D.C., 951-960.
Chung, S. Y., Hill, W. E., Doty, P., 1978. Proc. Natl. Acad. Sci. U.S.A 75(4), 1680-1684.
Cooper, G. S., Parks, C. G., Schur, P. S., Fraser, P. A., 2006. J. Toxicol. Environ. Health A 69(23), 2063-2069.
Davidson, A., Diamond, B., 2001. N. Engl. J. Med 345(5), 340-350.
Drouvalakis, K. A., Bangsaruntip, S., Hueber, W., Kozar, L. G., Utz, P. J., Dai, H., 2008. Biosens. Bioelectron. 23(10), 1413-1421.
Hernandez-Ruiz, J., Arnao, M. B., Hiner, A. N., Garcia-Canovas, F., Acosta, M., 2001. Biochem. J. 354(Pt 1), 107-114.
Hochberg, M. C., 1997. Arthritis Rheum. 40(9), 1725.
Ionescu, R. E., Cosnier, S., Herrmann, S., Marks, R. S., 2007. Anal. Chem. 79(22), 8662-8668.
Josephy, P. D., Eling, T., Mason, R. P., 1982. J. Biol. Chem. 257(7), 3669-3675.
Kurowska, E., Szymiczek, M., Gorczyca, W. A., Kuropatwa, M., 2006. J. Immunoassay Immunochem. 27(4), 331-340.
Lernmark, A., 2001. J. Clin. Invest 108(8), 1091-1096.
Lokate, A. M., Beusink, J. B., Besselink, G. A., Pruijn, G. J., Schasfoort, R. B., 2007. J. Am. Chem. Soc. 129(45), 14013-14018.
Lu, H., Goodell, V., Disis, M. L., 2008. J. Proteome. Res.
Lutter, L. C., 1978. J. Mol. Biol. 124, 391-420.
Melanson, S. E. F., 2007. Point of care: The Journal of near-patient testing and technology 6(2), 144-146.
Metzger, J., von Landenberg, P., Kehrel, M., Buhl, A., Lackner, K. J., Luppa, P. B., 2007. Clin. Chem. 53(6), 1137-1143.
Privett, B. J., Shin, J. H., Schoenfisch, M. H., 2008. Anal. Chem.
Rahman, A., Isenberg, D. A., 2008. N. Engl. J. Med 358(9), 929-939.
Ribone, M. E., Belluzo, M. S., Pagani, D., Macipar, I. S., Lagier, C. M., 2006. Anal. Biochem. 350(1), 61-70.
Rubin, R. L., Fritzler, M. J., 2007. In: Wallace, D. J., Hahn, B. H. (Eds.), Dubois' Lupus Erythematosus, 7th edit., Lippincott Williams & Wilkens, Philadelphia, 464-486.
Sheldon, J., 2004. Best. Pract. Res. Clin. Rheumatol. 18(3), 249-269.
Song, M. J., Yun, D. H., Min, N. K., Hong, S. I., 2007. J. Biosci. Bioeng. 103(1), 32-37.
Starita-Geribaldi, M., Sudaka, P., 1990. Bioseparation. 1(2), 111-117.
Tan, E. M., Cohen, A. S., Fries, J. F., Masi, A. T., McShane, D. J., Rothfield, N. F., Schaller, J. G., Talal, N., Winchester, R. J., 1982. Arthritis Rheum. 25, 1271-1277.
Tan, E. M., Zhang, J., 2008. Immunol Rev 222, 328-340.
Veetil, J. V., Ye, K., 2007. Biotechnol. Prog. 23(3), 517-531.
Wang, Y., Xu, H., Zhang, J., Guang, L., 2008. Sensors 8, 2043-2081.
Wikins, E., Sitdikov R., 2006. In: Knopf, G. K., Bassi, A. S. (Eds.), Smart Biosensor Technology, CRC Press, Boca Raton, Fla.
Wojciechowski, M., Sundseth, R., Moreno, M., Henkens, R., 1999. Clin. Chem. 45(9), 1690-1693.
Wu, J., Yan, F., Tang, J., Zhai, C., Ju, H., 2007. Clin. Chem. 53(8), 1495-1502.
Zifman, E., Amital, H., 2008. Isr. Med Assoc. J. 10(1), 29-31.

What is claimed is:

1. A method for detecting autoantibodies associated with an autoimmune disease in a human test sample comprising:
providing an electrochemical flow-through sensor comprising:
an inlet channel configured to deliver fluid into a reaction region;
a reaction region comprising:
an electrode assembly comprising a working electrode; and
immobilized autoantigens configured to present the product of an enzymatic reaction to the electrode assembly so as to produce a detectable alteration in the working electrode's signal output; and
an outlet channel configured to allow for fluid flow out of the reaction region, wherein the outlet channel is not the inlet channel;
introducing the test sample to the reaction region via the inlet channel under sufficient conditions for autoantibodies in the test sample to bind to the immobilized autoantigens;
allowing unbound molecules to exit the reaction region via the outlet channel;
introducing one or more detection molecules configured to, upon interaction with the bound autoantibodies, produce an enzymatic reaction, the product of which is able to produce a detectable alteration in the working electrode's signal output.

2. The method of claim 1 wherein the autoimmune disease is systemic lupus erythematosus.

3. The method of claim 1 wherein the autoantibodies are anti-chromatin autoantibodies.

4. The method of claim 1 wherein the immobilized autoantigens is H1-stripped chromatin.

5. The method of claim 4 wherein the human test sample is blood.

6. The method of claim 1 wherein the outlet channel runs through the working electrode.

7. A flow-through electrochemical apparatus for detecting autoantibodies associated with an autoimmune disease in a human test sample, the apparatus comprising:
a housing containing:
an inlet channel configured to deliver fluid into a reaction region;
a reaction region comprising:
an electrode assembly comprising a working electrode and a reference; and
immobilized autoantigens configured to present the product of an enzymatic reaction to the electrode assembly so as to produce a detectable alteration in the working electrode's signal output; and
an outlet channel configured to allow for fluid flow out of the reaction region, wherein the outlet channel is not the inlet channel.

8. The apparatus of claim 7 wherein the autoantigens are immobilized to a porous substrate.

9. The apparatus of claim 7 wherein the electrode assembly comprises at least one working electrode and at least once reference electrode.

10. The apparatus of claim 9 wherein the electrode assembly comprises a substrate.

11. The apparatus of claim 10 wherein the working and reference electrodes are screen-printed on a paper substrate.

12. The apparatus of claim 7 wherein the outlet channel travels through the working electrode.

13. The apparatus of claim 7 wherein the autoantigens are H1-stripped chromatin.

14. The apparatus of claim 7 further comprising a second inlet channel configured to deliver fluid into a second reaction region.

15. A flow-through electrochemical apparatus for detecting autoantibodies associated with an autoimmune disease in a human test sample, the apparatus comprising:
a housing containing:
a plurality of inlet channel configured to deliver fluid into a plurality of reaction regions, wherein each reaction region comprises:
an electrode assembly comprising a working electrode and a reference; and
immobilized autoantigens configured to present the product of an enzymatic reaction to the electrode assembly so as to produce a detectable alteration in the working electrode's signal output; and
a plurality of outlet channels configured to allow for fluid flow out of the reaction regions, wherein the outlet channels are not the inlet channels.

16. The apparatus of claim 15 wherein the plurality of reaction regions have the same autoantigens immobilized therein.

17. The apparatus of claim 16 wherein apparatus comprises a single porous substrate having the autoantigens immobilized thereto; and wherein the porous substrate is in fluid contact with each of the plurality of inlet channels.

18. The apparatus of claim 16 wherein the autoantigens are H1-stripped chromatin.

19. The apparatus of claim 15 wherein the apparatus contains a single substrate including a plurality of electrode assemblies and wherein each inlet channel delivers fluid to a different electrode assembly on the single substrate.

20. The apparatus of claim 15 wherein at least two of the reaction regions have different autoantigens immobilized therein.
